(19) United States
(12) Patent Application Publication
(10) Pub. No.: US 2017/0057758 A1
(43) Pub. Date: Mar. 2, 2017

(54) PNEUMATIC CONVEYING VESSEL

(71) Applicant: Siemens Aktiengesellschaft, Munich (DE)

(72) Inventors: Dietmar Degenkolb, Freiberg (DE); Ronny Ehrich, Freiberg (DE); Frank Hannemann, Freiberg (DE); Marcus Weder, Bannewitz OT Hanichen (DE)

(73) Assignee: Siemens Aktiengesellschaft, Munich (DE)

(21) Appl. No.: 15/235,467

(22) Filed: Aug. 12, 2016

(30) Foreign Application Priority Data
Aug. 26, 2015 (DE) 102015216320.2

(51) Int. Cl. B65G 53/22

(52) U.S. Cl. CPC B65G 53/22; B65G 2201/045; B65G 2812/1658

(57) ABSTRACT

A feed-in container for fluidizing and conveying products in dust form, such as, for example, coal dust, using conveying gases under pressures up to 7 MPa, in which the fluidizing floor is fastened by a central tubular supporting construction. A stable and low-outlay construction takes up the weight and pressure loading of the fluidizing floor. An emptying line is arranged in the supporting construction, making a separate opening through the fluidizing floor obsolete and thus providing a low-outlay passage through the fluidizing floor. The supporting construction is also designed such that it serves as a shaft guide for an agitator.

### CROSS REFERENCE TO RELATED APPLICATIONS

This application claims the benefit of German Application No. DE 102015216320.2 filed 26 Aug. 2015, incorporated by reference herein in its entirety.

### FIELD OF INVENTION

The invention relates to an apparatus for fluidizing and conveying products in dust form, such as, for example, coal dust, using conveying gases under pressures up to 7 MPa.

### BACKGROUND OF INVENTION

Continuous and cost-effective dense stream conveying with changing dust quality of pulverized fuels for coal and biomass gasification plants is becoming ever increasingly important in order to operate gasification plants economically and with high availability. The varied dust quality is substantially characterized by changes in the moisture and the particle size distribution. Currently operated entrained gasifiers with pneumatic dense flow conveying are susceptible to faults owing to this changing dust quality or do not achieve the desired conveying densities. A high conveying density is required for a compact design and a reduction in the amounts of conveying gas and thus for a high plant efficiency.

Patent document DE 102012216084 discloses an improved fluidizing floor composed of a wire mesh, sintered metal or plastic. The use of these new filter materials results in the creation of a more homogeneous fluidized bed which allows more stable dust conveying. A disadvantage is the mechanical fastening of the fluidizing floor on the conveying container and of the filter material, which leads to detachments and thus conveying disturbances and also to a more complicated container construction and associated higher costs.

### SUMMARY OF INVENTION

The object on which the invention is based is to provide an apparatus which allows low-outlay and fault-free fluidizing and conveying of dusts under pressures up to 7 MPa at high dust densities and for different dust qualities.

The problem is solved by an apparatus for fluidizing and conveying dusts having the features of the independent claim.

The central fastening of the annular fluidizing floor on the tubular supporting construction provides a stable construction for taking up the weight and pressure loading of the fluidizing floor, which is particularly relevant for the high pressure differences occurring during the startup and shutdown of the feed-in container. A hitherto necessary complicated mounting via a double flange connection is avoided.

An emptying line can be arranged in the supporting construction, making an otherwise necessary separate opening through the fluidizing floor obsolete and thus advantageously providing a low-outlay passage through the fluidizing floor.

In an advantageous manner, the supporting construction can be designed in such a way that it serves as a shaft guide for an agitator.

Advantageous developments of the invention are specified in the dependent claims.

### BRIEF DESCRIPTION OF THE DRAWINGS

The invention will be explained in more detail below as an exemplary embodiment to an extent required for understanding by way of figures, in which:

FIG. 1 shows an apparatus for fluidizing and conveying the coal dust upward out of the container;

FIG. 2 shows an apparatus for fluidizing and conveying the coal dust downward out of the dished bottom; and

FIG. 3 shows an apparatus for fluidizing and conveying the coal dust downward out of the dished bottom with central emptying and without agitator.

### DETAILED DESCRIPTION OF INVENTION

In the figures, the detail X in each case shows particulars of the fluidizing floor and its fastening on the flange 15 on the outside and on the supporting construction 8 on the inside.

Identical designations denote identical elements in the figures.

The apparatus comprises a fluidizing floor 4, 5, a dished bottom 11 which is flanged onto a conveying container 12, and a supporting construction 8 which is welded centrally onto the dished bottom and which has the task not only of centrally fixing and fastening the fluidizing floor, comprising a baseplate 4 with openings and a filter element 5, but also, at the same time, of performing the function of an agitator leadthrough. For this purpose, the fluidizing floor is configured as a circular ring, the inner part of the ring being placed on the centrally arranged tubular supporting construction 8 and being screwed gastight by means of a hexagon socket screw 7. In order to secure the supporting construction against pressure loading and at the same time to be able to achieve a directed flow for sealing in the direction of the fluidizing shaft, additional pressure equalizing bores 9 are present in the supporting device. During operation, the pressure in the fluidizing shaft is lower by at least 20 mbar than the pressure in the interior of the dished bottom, with substantially higher pressure differences occurring in the startup and shutdown state.

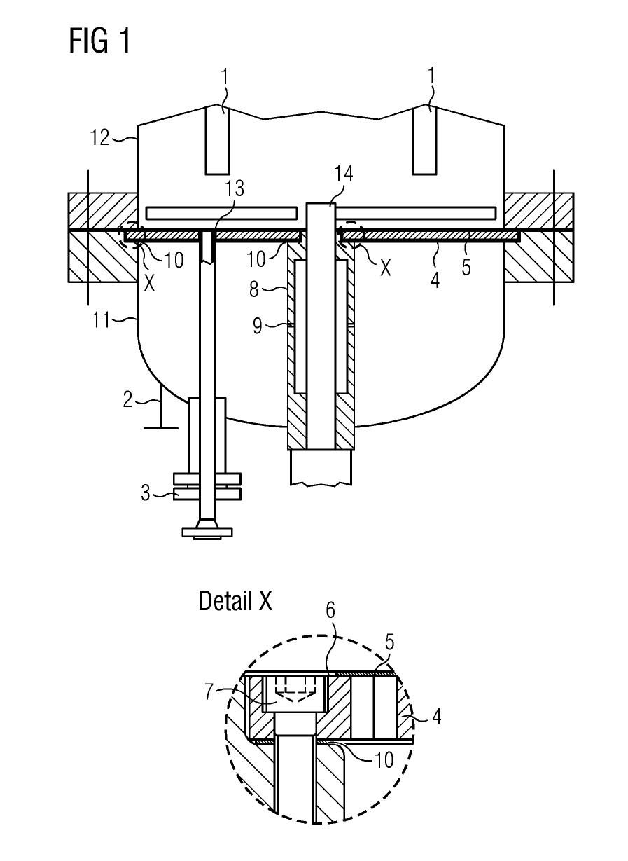

The central fastening of the annular fluidizing floor on the tubular supporting construction makes it possible to avoid complicated mounting via a double flange connection for taking up the weight and pressure loading of the fluidizing floor. The fluidizing floor is advantageously in addition screwed in the flange connection between the conveying container 12 and dished bottom 11 by means of hexagon socket screws 7 (FIG. 1).

A further feature of the apparatus consists in the fact that the fluidizing floor is produced from a filter material which is welded flat onto the baseplate 4 having openings. Here, the openings in the baseplate can be configured in various ways (round bores and/or slots). For a particularly advantageous embodiment, the openings are symmetrically arranged, thereby achieving a uniform distribution of the fluidizing gas. The filter material is welded flat to the baseplate, with the result that a high strength with respect to changing differential pressures is achieved at the same time. The filter material is preferably composed of a comparable material to the baseplate, with the result that a simple welded connection can be achieved by means of a capacitor pulse welding process, a process using flat electrodes or other induction welding processes. Alternatively, fastening of the filter material can also be achieved by sintering on the baseplate. The filter material preferably consists of a wire mesh, but can also be produced from metal foam or sintered metal. As a result of the filter material being welded flat to the baseplate, a high stability is provided in the case of large differential pressure without it being possible for the filter material to be mechanically destroyed.

To empty the fluidizable dusts from the conveying container, there is integrated into the fluidizing apparatus an emptying line 3 which is flanged on the dished bottom and is routed through an opening in the fluidizing floor with the aid of a seal into the fluidizing shaft of the conveying container.

In the case of dusts which are difficult to fluidize, the central supporting construction is configured as an agitator leadthrough and accommodates the shaft of the agitator.

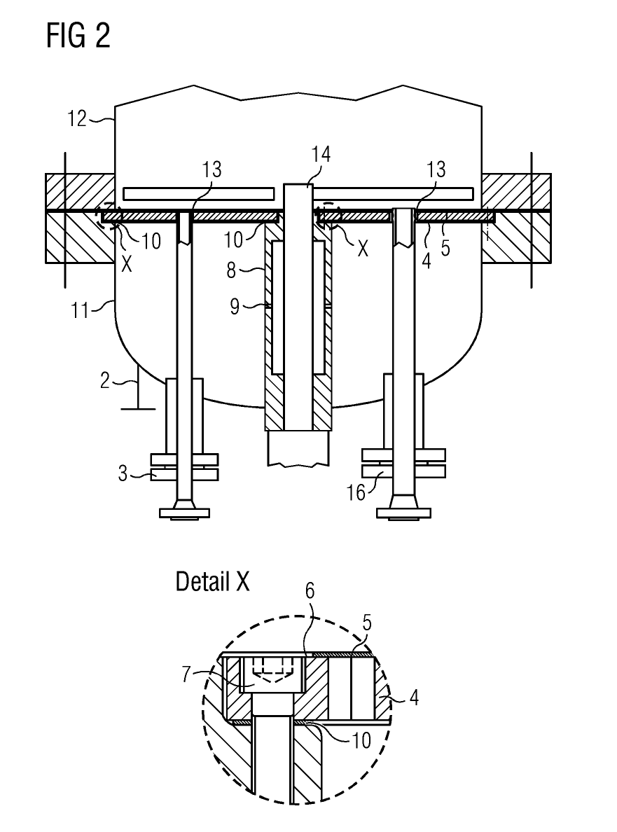

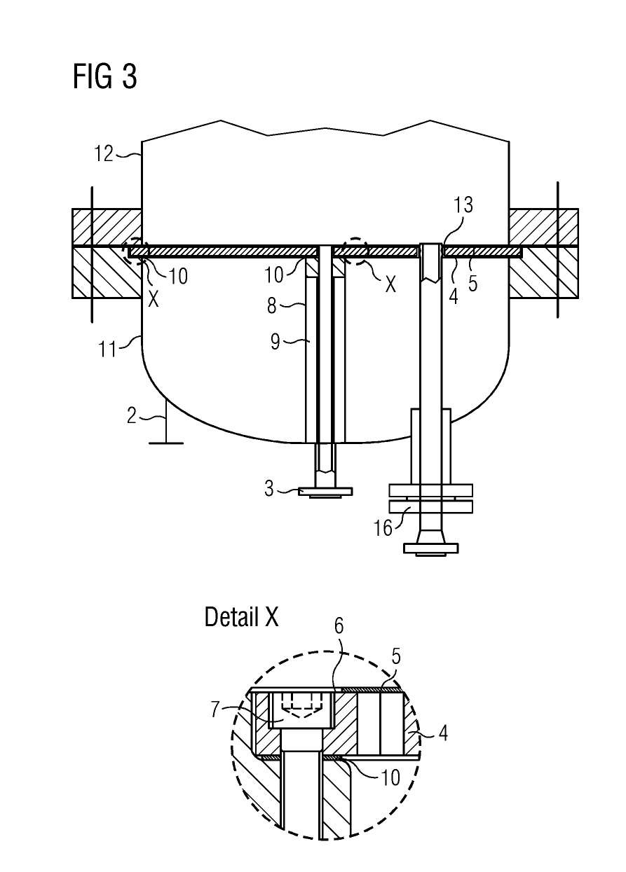

In a particularly advantageous embodiment of the apparatus, the conveying lines 16 for discharging the fluidized dust are routed vertically downward through openings in the fluidizing floor and through the dished bottom (FIGS. 2 and 3). Here, the conveying lines can be fastened via a flange connection to the dished bottom and be simultaneously distributed over the surface of the fluidizing floor. The leadthroughs on the fluidizing floor are freely movable and are sealed via seals and, here preferably, O-ring seals 13. In order to achieve good fluidizing, the inlet of the conveying line is arranged at least 5 mm above the fluidizing floor and the spacing of the agitator blades is at least 10 mm above the conveying line.

In a simpler embodiment, the inlet of the conveying lines 1 can be arranged above the agitator and the conveying lines can be routed vertically upward out of the container (FIG. 1).

In the case of dusts which can be fluidized easily, an agitator can be dispensed with (FIG. 3). In this case, the necessary emptying line is advantageously integrated into the centrally arranged supporting construction 8, it being possible to dispense with additional openings in the annular fluidizing floor.

The invention is also provided by an apparatus for fluidizing dusts in which an annularly configured fluidizing floor 4, 5 is screwed on the outer edge into a flange connection of the feed-in container 12 and is screwed gastight with the aid of a flat seal 10 in the inner necking on a supporting construction 8 and bears a baseplate 4 which is coated with filter material 5.

In a further refinement of the invention, the supporting device 8 is welded to a dished bottom 11.

In a further refinement of the invention, the baseplate 4 of the fluidizing floor is welded homogeneously over its whole surface to the filter material 5.

In a further refinement of the invention, the baseplate 4 is connected flat to the filter material 5 by a sintering process.

In a further refinement of the invention, the fluidizing floor 4, 5 contains additional openings with O-ring seals for emptying and dust conveying lines.

In a further refinement of the invention, the conveying lines are routed downward out of the dished bottom 11, are screwed with flange connections welded onto the dished bottom and terminate at least 5 mm above the fluidizing floor.

In a further refinement of the invention, the conveying lines 1 are routed upward out of the feed-in container and terminate at least 10 mm above the fluidizing floor.

In a further refinement of the invention, an agitator is arranged above the fluidizing floor and the supporting device 8 is configured as an agitator leadthrough.

In a further refinement of the invention, the supporting device 8 contains an emptying line 3.

The present invention has been explained in detail for illustration purposes with reference to specific exemplary embodiments. Here, elements of the individual exemplary embodiments can also be combined with one another. The invention is therefore not intended to be limited to individual exemplary embodiments but only to be subject to a limitation by the appended claims.

### LIST OF REFERENCE SIGNS

1 Conveying line (upward conveying)
2 Fluidizing gas supply
3 Residue emptying line
4 Perforated plate
5 Wire fabric filter (welded over its whole area to 4)
6 Fillet weld for 4/5
7 Hexagon socket screw
8 Supporting construction for fluidizing floor mounting/agitator shaft guide
9 Pressure equalizing bore
10 Flat seal
11 Elliptical bottom, dished bottom, arcuate bottom
12 Feed-in container with fluidizing shaft
13 O-ring seal
14 Agitator with arms
15 Flange connection for bottom
16 Conveying line (downward conveying).

1. An apparatus for fluidizing and conveying dusts, comprising:
a fluidizing floor which is arranged in the lower region of a feed-in container,
an accumulation of dust which is provided in the fluidizing shaft of the feed-in container above the fluidizing floor,
a fluidizing gas which is supplied below the fluidizing floor in order to produce a fluidized bed in the accumulation of dust,
a conveying line that dips into the fluidized bed in order to remove fluidized dust,
wherein the feed-in container is closed off by a bottom at the lower end via a flange connection, and
a central, tubular supporting construction which is arranged between the bottom and the fluidizing floor.

2. The apparatus as claimed in claim 1,
wherein the bottom takes the form of a dished bottom.

3. The apparatus as claimed in claim 1,
wherein the feed-in container and the fluidizing floor have a circular cross section.

4. The apparatus as claimed in claim 1,
wherein the separating point of the flange connection and the upper end of the supporting construction lie in the plane of the fluidizing floor.

5. The apparatus as claimed in claim 1,
wherein the fluidizing floor is formed by a perforated baseplate which is coated with filter material.

6. The apparatus as claimed in claim 5,
wherein the baseplate of the fluidizing floor is homogeneously welded over its whole surface to the filter material.

7. The apparatus as claimed in claim 5,
wherein the baseplate is connected flat to the filter material by a sintering process.

8. The apparatus as claimed in claim 1,
wherein the dust conveying line is routed upward out of the feed-in container.

9. The apparatus as claimed in claim 1,
wherein the dust conveying line, which penetrates the fluidizing floor, is routed downward out of the feed-in container.

10. The apparatus as claimed in claim 1, further comprising:
an agitator with stirring arms which is arranged above the fluidizing floor and
wherein the supporting construction is configured as an agitator leadthrough for the shaft of the agitator.

11. The apparatus as claimed in claim 1,
wherein the supporting construction contains an emptying line for emptying the dust from the feed-in container.

12. The apparatus as claimed in claim 1,
wherein the feed-in container is equipped for pulverized fuels under pressures up to 7 MPa.

13. The apparatus as claimed in claim 1,
wherein the supporting construction has pressure equalizing bores.
